(19) United States
(12) Patent Application Publication
(10) Pub. No.: US 2012/0063872 A1
(43) Pub. Date: Mar. 15, 2012

(54) Attachment for handling bales of hay

(76) Inventor: Jacques Messier, Alfred (CA)

(21) Appl. No.: 13/229,671

(22) Filed: Sep. 10, 2011

(30) Foreign Application Priority Data
Sep. 10, 2010 (GB) 1015129.8

(51) Int. Cl. B66F 9/19; B66F 9/065

(52) U.S. Cl. 414/592; 414/785

(57) ABSTRACT

An attachment for handling hay bales comprising a fork member having a bottom portion including a plurality of tines, and a back portion attached to the bottom portion and extending perpendicularly upwards therefrom. A hydraulically operated push frame member having a shape and size that is similar to the back portion. An articulated frame attached between the back portion and the push frame that is adapted to push the push frame linearly from one end of the tines adjacent the back portion to a distal end of the tines, the articulated frame including an elongated rod member rotatably attached to the back portion, a piston adapter member attached to the rod member and adapted to be pivotally attached to a hydraulic cylinder for rotating the rod member when the hydraulic cylinder is actuated.

This application claims priority based on request GB1015129.8 filed Sep. 10, 2010

### FIELD OF THE INVENTION

The present invention relates generally to handling apparatus but more particularly to an attachment for handling one or more bales of hay.

### BACKGROUND OF THE INVENTION

There are hundreds if not thousands of devices that have been invented over the centuries for the farming and agricultural sector. As mechanization became more prominent, it became feasible to handle loads that were previously too heavy and as such new types of accessories and attachments needed to be devised to handle those loads.

### SUMMARY OF THE INVENTION

In view of the foregoing disadvantages inherent in the known devices now present in the prior art, the present invention, which will be described subsequently in greater detail, is to provide objects and advantages which are:

To provide for an attachment that can be used on a farm tractor having a loader as a replacement to the bucket and which can carry one or more bales of hay.

In order to do so, the attachment for handling hay bales comprising a fork member having a bottom portion including a plurality of tines, and a back portion attached to the bottom portion and extending perpendicularly upwards therefrom. A hydraulically operated push frame member having a shape and size that is similar to the back portion. An articulated frame attached between the back portion and the push frame that is adapted to push the push frame linearly from one end of the tines adjacent the back portion to a distal end of the tines, the articulated frame including an elongated rod member rotatably attached to the back portion, a piston adapter member attached to the rod member and adapted to be pivotally attached to a hydraulic cylinder for rotating the rod member when the hydraulic cylinder is actuated; and at least one articulated arm member attached between the rod member and the push frame and adapted to fold when the rod member is turned in one direction and extend when the rod member is turned in an opposite direction thereby pulling and pushing the push frame, and thereby adapted to push off a hay bale when the attachment is in a desired position.

The attachment is further comprised of a top member pivotally attached to a top portion of the back member, the top member having a rectangular shape and adapted to cover a top surface of a hay bale, and having a flip fork at a distal edge spaced from the edge adjacent the back member, the flip fork adapted to stick into and grab a hay bale.

The top member includes a hydraulic cylinder pivotally attached between the back member and the edge adjacent the back member, and adapted to pivotally raise and lower the top member toward and away from a top surface of a hay bale.

The flip fork comprises an elongated bar member pivotally attached to the distal edge of the top member, and includes a plurality of tines adapted to stick into and grab the hay bale.

The attachment further comprises at least one chain member connected between the back member and the push frame and adapted to limit the forward movement of the push frame and to steady the push frame once a hay bale is pushed off the bottom member.

The bottom portion is fork shaped, and the back portion is attached at an edge of the bottom portion from wherein the tines extend therefrom.

At least one articulated arm member is pivotally attached to the push frame, and comprises two arm portions that are pivotally connected to one another at adjacent ends thereof.

The attachment where the articulated arm member includes two articulated arm members separated from one another and attached to the rod member and to the push frame at points that are equally separated from one another; and wherein the two articulated arm members are pivotally attached to the back member and the push frame, and wherein each articulated arm member comprises two arm portions that are pivotally connected to one another at adjacent ends thereof.

The attachment is adapted to be removably attached to a drivable and movable piece of machinery, such that the hydraulic cylinders are connected thereto and controlled therefrom.

A combination of a drivable and movable piece of machinery and an attachment removably attached thereto for handling hay bales, the combination comprising a drivable and movable piece of machinery including attachment members adapted to hydraulically and removably connect the attachment thereto and an attachment comprising a fork member having a bottom portion including a plurality of tines, and a back portion attached to the bottom portion and extending perpendicularly upwards therefrom. a hydraulically operated push frame member having a shape and size that is similar to the back portion. An articulated frame attached between the back portion and the push frame that is adapted to push the push frame linearly from one end of the tines adjacent the back portion to a distal end of the tines, the articulated frame including an elongated rod member rotatably attached to the back portion, a piston adapter member attached to the rod member and adapted to be pivotally attached to a hydraulic cylinder for rotating the rod member when the hydraulic cylinder is actuated. At least one articulated arm member attached between the rod member and the push frame and adapted to fold when the rod member is turned in one direction and extend when the rod member is turned in an opposite direction thereby pulling and pushing the push frame, and thereby adapted to push off a hay bale when the attachment is in a desired position.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view of the invention.

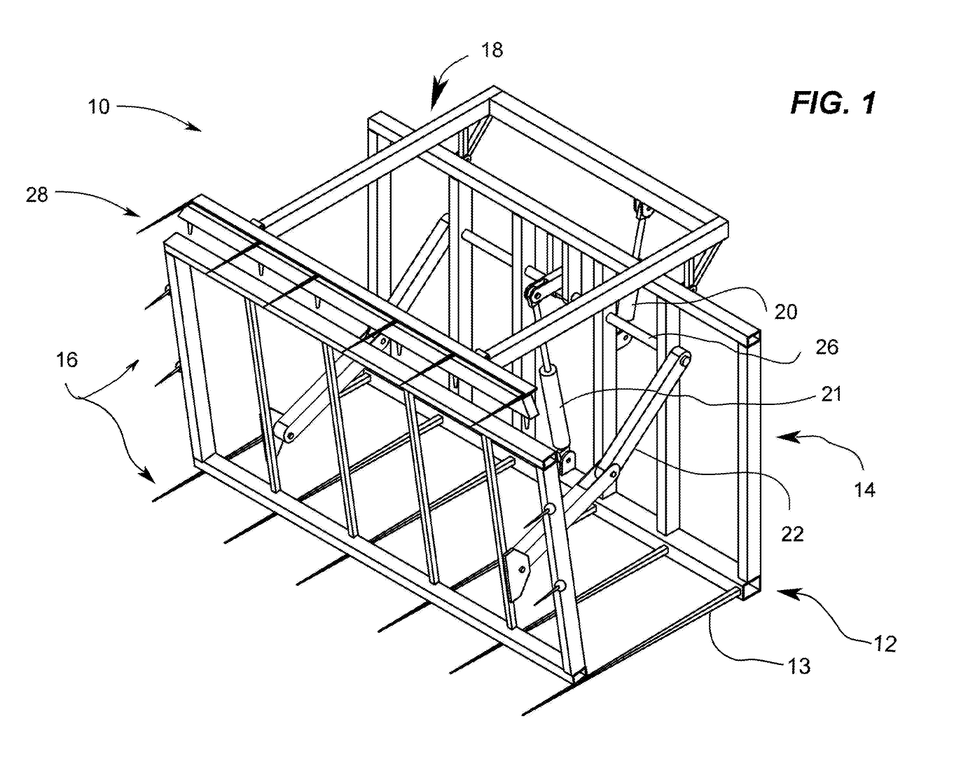

FIGS. 2a-b Side views of the invention in two modes.

FIG. 3 Reverse angle view of FIG. 1.

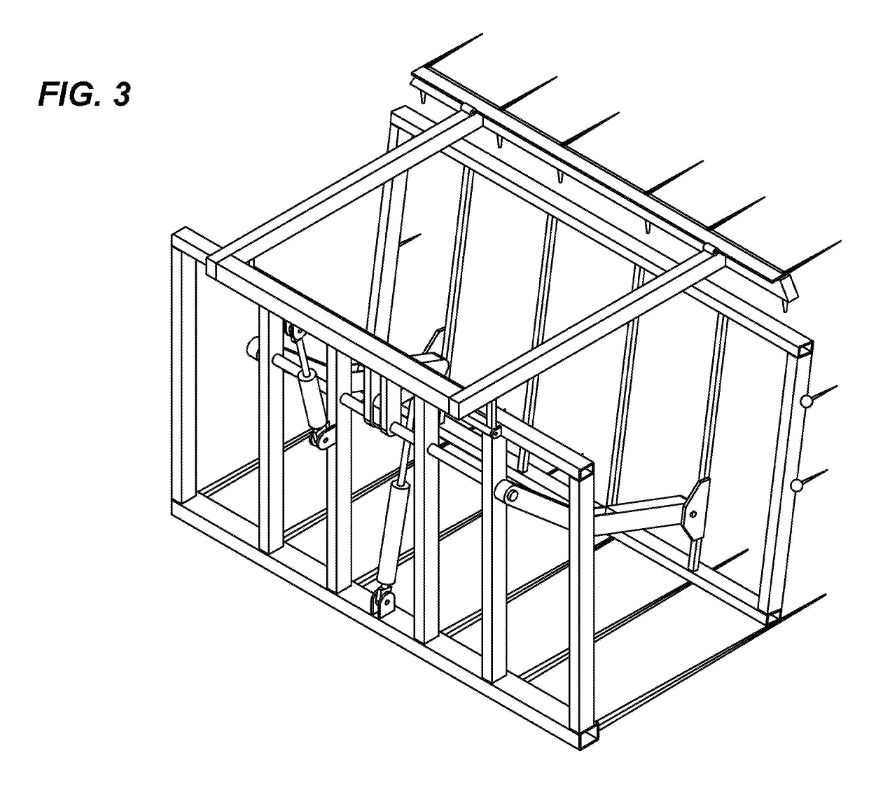

FIG. 4 Isometric view with top member up.

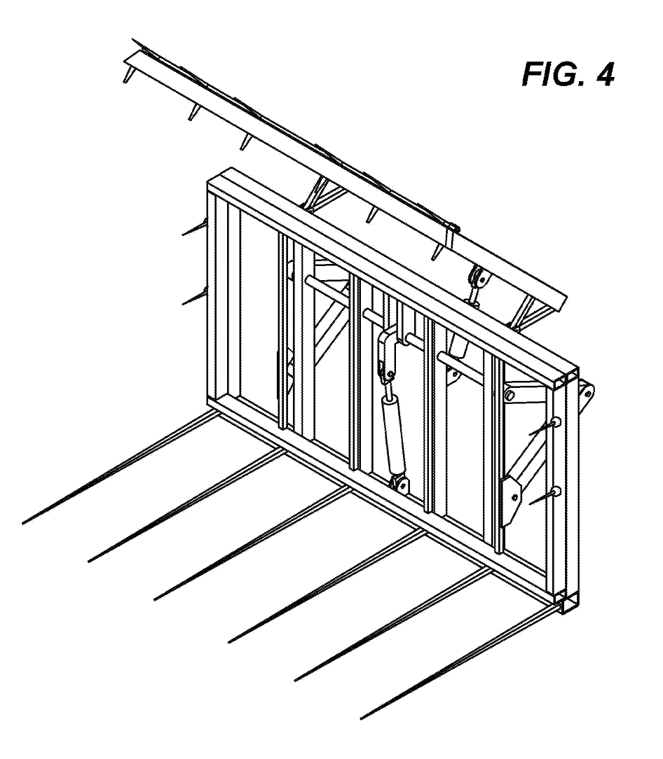

FIG. 5 Reverse angle view of FIG. 4.

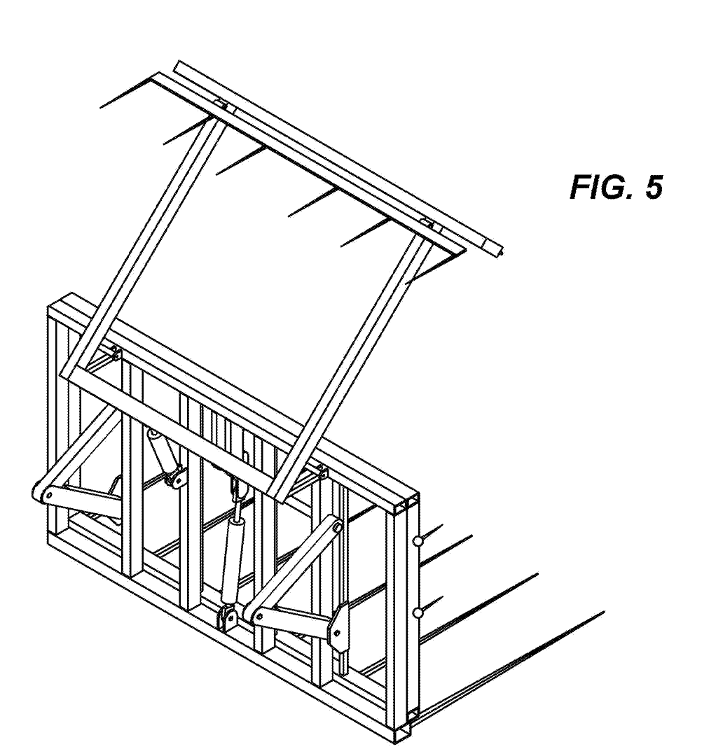

FIG. 6 Side view of the invention attached to a farm tractor.

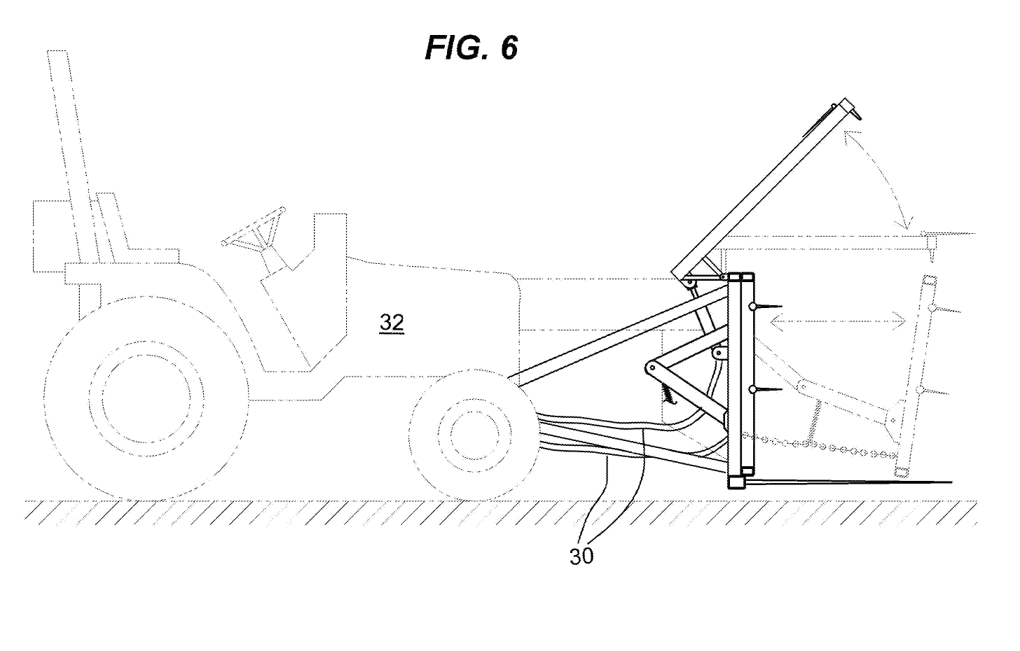

FIGS. 7a-b Top and front views, respectively, of the invention.

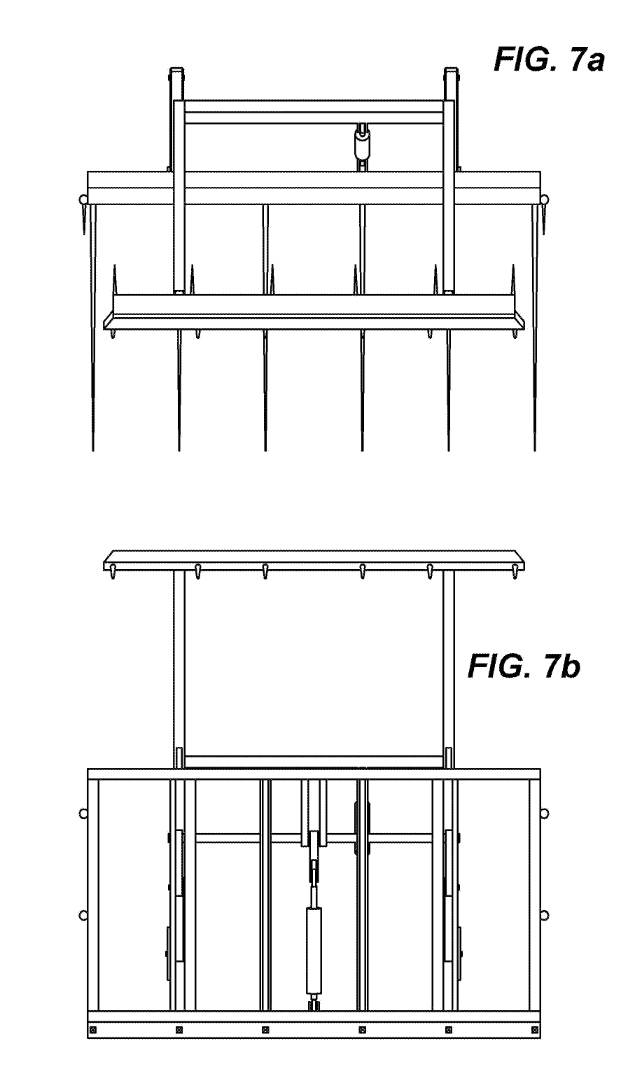

### DETAILED DESCRIPTION OF THE PREFERRED EMBODIMENT

An attachment for handling hay bales (10) has a fork member (12) having a bottom portion (13) including a plurality of tines (16), and a back portion (14) attached to the bottom portion (13) and extending perpendicularly upwards therefrom. A hydraulically actuated push frame (16) as well as a hydraulically actuated top member (18).

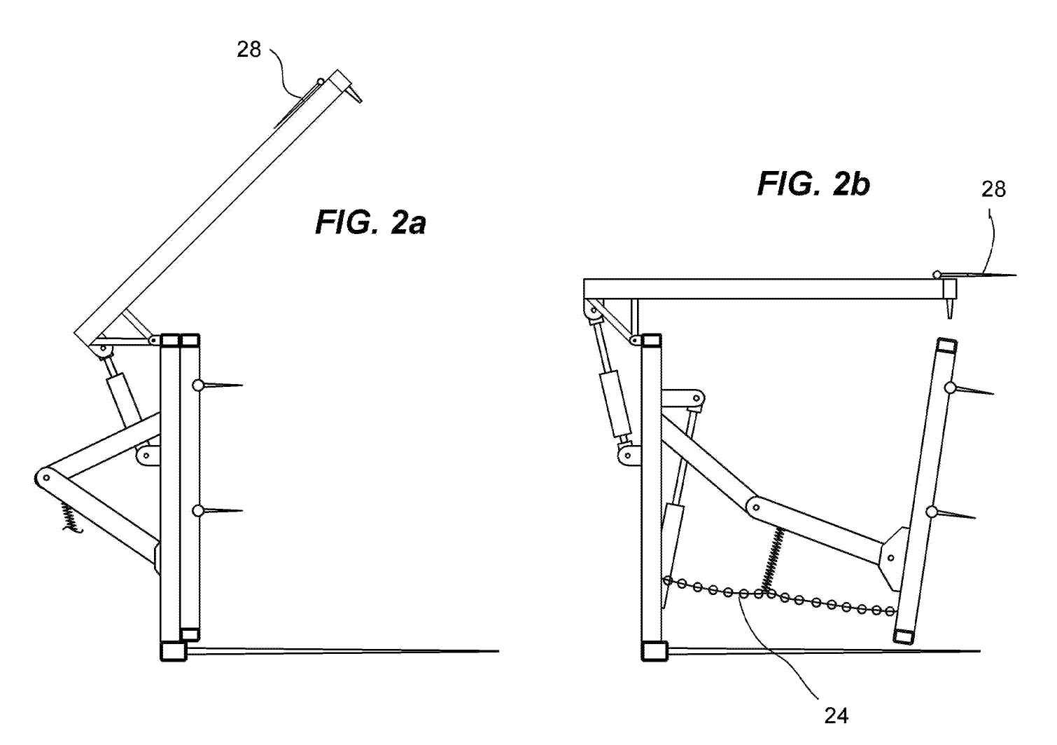

When a user wants to carry bales (not shown) he simply picks one or more by sliding the fork member (12) underneath the bales until the bales hit the push frame (16) which, at this point, is against the back portion (14), as per FIG. 2a. Then, the top member (18) is lowered so as to squeeze the bales tight.

In order to remove the bale or bales from the attachment (10), the top member (18) is raised and the push frame (16) pushes the one or more bales by moving forward and away from the back portion (14), as per FIG. 2b.

Besides the aforementioned components, there is a top member piston (20) to actuate the top member (18), and an an articulated frame piston (21) to actuate the push frame (16) by way of an articulated frame (22) connecting the back portion (14) with the push frame (16). There is also a chain (24) attached to a side of the back portion (14) to push the frame (16) in order to avoid interfering with the hay bale, and limit the forward movement of the frame (16). The articulated frame (22) is connected to a rod (26), itself rotationally attached to the back portion (14). The articulated frame (22) pushed by the action of the articulated frame piston (21). Both the articulated frame piston (21) and the top member piston (20) are actuated by way of hydraulic lines (30) coming from a tractor (32) as is known in the art.

Also, as seen in FIG. 2b, a flip fork (28) located at the front of the top member (18) can be used when loading bales at the very top of a van or truck where the bales need to be squeezed under the van's roof. At this point, the bales are impaled by the flip fork (28) then pushed and squeezed into place without having the top member (18) interfering with the roof of the van or truck.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An attachment for handling hay bales comprising a fork member having a bottom portion including a plurality of tines, and a back portion attached to said bottom portion and extending perpendicularly upwards therefrom; a hydraulically operated push frame member having a shape and size that is similar to said back portion; an articulated frame attached between said back portion and said push frame that is adapted to push said push frame linearly from one end of said tines adjacent said back portion to a distal end of said tines, said articulated frame including an elongated rod member rotatably attached to said back portion, a piston adapter member attached to said rod member and adapted to be pivotally attached to a hydraulic cylinder for rotating said rod member when said hydraulic cylinder is actuated; and at least one articulated arm member attached between said rod member and said push frame and adapted to fold when said rod member is turned in one direction and extend when said rod member is turned in an opposite direction thereby pulling and pushing said push frame, and thereby adapted to push off a hay bale when said attachment is in a desired position.

2. The attachment of claim 1, further comprising a top member pivotally attached to a top portion of said back member, said top member having a rectangular shape and adapted to cover a top surface of a hay bale, and having a flip fork at a distal edge spaced from said edge adjacent said back member, said flip fork adapted to stick into and grab a hay bale.

3. The attachment of claim 2, wherein said top member includes a hydraulic cylinder pivotally attached between said back member and said edge adjacent said back member, and adapted to pivotally raise and lower said top member toward and away from a top surface of a hay bale.

4. The attachment of claim 2, wherein said flip fork comprises an elongated bar member pivotally attached to said distal edge of said top member, and includes a plurality of tines adapted to stick into and grab said hay bale.

5. The attachment of claim 1, further comprising at least one chain member connected between said back member and said push frame and is adapted to limit the forward movement of said push frame and to steady said push frame once a hay bale is pushed off said bottom member.

6. The attachment of claim 1, wherein said bottom portion is fork shaped, and wherein said back portion is attached at an edge of said bottom portion from wherein said tines extend therefrom.

7. The attachment of claim 1, wherein said at least one articulated arm member is pivotally attached to said push frame, and comprises two arm portions that are pivotally connected to one another at adjacent ends thereof.

8. The attachment of claim 1, wherein said at least one articulated arm member includes two articulated arm members separated from one another and attached to said rod member and to said push frame at points that are equally separated from one another; and wherein said two articulated arm members are pivotally attached to said back member and said push frame, and wherein each articulated arm member comprises two arm portions that are pivotally connected to one another at adjacent ends thereof.

9. The attachment of claim 1, wherein said attachment is adapted to be removably attached to a drivable and movable piece of machinery, such that said hydraulic cylinders are connected thereto and controlled therefrom.

10. A combination of a drivable and movable piece of machinery and an attachment removably attached thereto for handling hay bales, said combination comprising a drivable and movable piece of machinery including attachment members adapted to hydraulically and removably connect said attachment thereto; and an attachment comprising a fork member having a bottom portion including a plurality of tines, and a back portion attached to said bottom portion and extending perpendicularly upwards therefrom; a hydraulically operated push frame member having a shape and size that is similar to said back portion; an articulated frame attached between said back portion and said push frame that is adapted to push said push frame linearly from one end of said tines adjacent said back portion to a distal end of said tines, said articulated frame including an elongated rod member rotatably attached to said back portion, a piston adapter member attached to said rod member and adapted to be pivotally attached to a hydraulic cylinder for rotating said rod member when said hydraulic cylinder is actuated; and at least one articulated arm member attached between said rod member and said push frame and adapted to fold when said rod member is turned in one direction and extend when said rod member is turned in an opposite direction thereby pulling and pushing said push frame, and thereby adapted to push off a hay bale when said attachment is in a desired position.

11. The attachment of claim 10, further comprising a top member pivotally attached to a top portion of said back member, said top member having a rectangular shape and adapted cover a top surface of a hay bale, and having a flip fork at a distal edge spaced from said edge adjacent said back member, said flip fork adapted to stick into and grab a hay bale.

12. The attachment of claim 11, wherein said top member includes a hydraulic cylinder pivotally attached between said back member and said edge adjacent said back member, and adapted to pivotally raise and lower said top member toward and away from a top surface of a hay bale.

13. The attachment of claim 11, wherein said flip fork comprises an elongated bar member pivotally attached to said distal edge of said top member, and includes a plurality of tines adapted to stick into and grab said hay bale.

14. The attachment of claim 10, further comprising at least one chain member connected between said back member and said push frame and is adapted to limit the forward movement of said push frame and to steady said push frame once a hay bale is pushed off said bottom member.

15. The attachment of claim 10, wherein said bottom portion is fork shaped, and wherein said back portion is attached at an edge of said bottom portion from wherein said tines extend therefrom.

16. The attachment of claim 10, wherein said at least one articulated arm member is pivotally attached to said push frame, and comprises two arm portions that are pivotally connected to one another at adjacent ends thereof.

17. The attachment of claim 10, wherein said at least one articulated arm member includes two articulated arm members separated from one another and attached to said rod member and to said push frame at points that are equally separated from one another; and wherein said two articulated arm members are pivotally attached to said back member and said push frame, and wherein each articulated arm member comprises two arm portions that are pivotally connected to one another at adjacent ends thereof.

18. The attachment of claim 10, wherein said drivable and movable piece of machinery is chosen from a list of drivable and movable pieces of machinery including a tractor, a bull dozer, a front end loader, and a fork lift.

19. The attachment of claim 10, wherein said attachment members of said drivable and movable piece of machinery includes hydraulic lines removably attachable to the hydraulic cylinders of said articulated frame and said top member.
